(19) United States
(12) Patent Application Publication
(10) Pub. No.: US 2010/0303060 A1
(43) Pub. Date: Dec. 2, 2010

(54) SECOND CALL MODE CALL SET-UP BETWEEN TWO USERS

(75) Inventors: Susana Goncalves, Clamart (FR); Grégoire Jozan, Paris (FR); Ronan Le Roux, Issy Les Moulineaux (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/789,155

(22) Filed: May 27, 2010

(30) Foreign Application Priority Data
May 28, 2009 (FR) 09 53532

(51) Int. Cl. H04L 12/66

(52) U.S. Cl. 370/352

(57) ABSTRACT

A method is provided of setting up a call between first and second users having respective first and second application identifiers, shared between the users, the first user being connected to a communications application and being adapted to communicate in a first call mode with the second user, adapted to receive a connection request, to obtain an identifier of a second call mode of the first user and an identifier of the second mode of the second user and to set up a second call mode call between the two users as a function of the identifiers obtained. In addition, a method is provided of requesting the setting up of a second mode call between the first user and the second user, the first user being connected to a communications application and being adapted to communicate in a first call mode with the second user, adapted to send a connection request. A terminal and a server respectively are provided for implementing the call set-up request method and the call set-up method.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates generally to the field of telecommunications.

It relates more particularly to an interpersonal connection method enabling a second call to be set up between two users connected by a first call at the request of one of them whilst preserving the anonymity of both of them.

### BACKGROUND OF THE DISCLOSURE

Known systems enable close or unknown users to communicate via different applications with an identity respecting the anonymity of the users. These systems are, for example, social networks (Facebook (Registered Trade Mark), MeeticAffinity (Registered Trade Mark) etc.) or instant messaging systems.

In particular, instant messaging systems enable text messages to be exchanged instantaneously between a plurality of computers connected to the same computer network, for example the Internet. These instant messaging systems require the use of client software that connects to a remote instant messaging server.

Use thereof requires a preliminary registration phase during which the user communicates to the server an identifier that is specific to the service. This identifier is for example a pseudonym chosen by the user.

The user can then communicate with other users using this identifier, which constitutes an identity visible to other users.

This identifier enables users to communicate with other users without revealing their identities and thus to preserve their anonymity.

If users wish to communicate via other communications means, for example to continue to communicate via a telephone conversation or electronic mail, they must communicate information about their personal details, for example a personal telephone number or an electronic mail address.

These details specific to the user make it possible to find out the identity of the user and therefore fail to preserve the anonymity of the user.

Some systems offer telephone aliases, i.e. telephone numbers specifically assigned for a predetermined duration and associated with the user's personal telephone number. In those systems, only the aliases are communicated. When one user calls another user, it is the alias that is used and the call is transferred to other user's telephone without communicating a personal number.

Those systems require the use of a large number of additional telephone accounts, thereby generating a heavy management burden and additional cost.

There therefore exists a requirement for a more satisfactory solution.

### SUMMARY

An aspect of the present disclosure relates to a method of setting up a call between first and second users having respective first and second application identifiers, said first and second application identifiers being shared between the users, the first user being connected to a dedicated communications application via a first communications module and using the first application identifier, and the first communications module being able to communicate in a first call mode with the second user using the second application identifier, wherein the method includes:
a step of receiving from the first communications module a connection request including the first and second application identifiers;
a step of obtaining at least one identifier of a second call mode of the first user and at least one identifier of the second call mode of the second user as a function of the first and second application identifiers;
a step of storing in a memory the association between the second call mode identifiers of the first and second users; and
a step of setting up a call between the first and second users in the second call mode as a function of the stored associated identifiers.

Accordingly, at the request of one user, a server sets up anonymously a new call between the users. This call advantageously uses the personal details of the users, for example their personal telephone number or electronic mail addresses, and does not require new details to be set up. The users can therefore have a telephone conversation using their personal terminals, for example, without their telephone numbers being exchanged between them. Thus the anonymity of the users is respected.

In one particular implementation, the set-up method further includes a communications step initiated by a second communications module of the first user using a predetermined call identifier and the call set-up step includes a step of calling a second communications module of the second user. In this implementation, the user initiates the second call mode call by calling a connection server. The called server retrieves the telephone number of the second user and sets up the call between the two users. This implementation facilitates billing a call at the initiative of the first user.

According to one particular feature of this implementation, the call identifier is sent in response to the connection request.

It is easy for the user to send a call identifier, for example a telephone number of a call server. Moreover, it makes it possible to split call set-up tasks between different call servers.

In the set-up method of another particular implementation, the call set-up step includes a first step of calling a second communications module of the first user and a second step of calling a second communications module of the second user.

This implementation has the advantage of simplifying the actions of the first user, for example. Setting up a call does not require the user to enter a telephone number.

In the set-up method of one particular implementation, the modules for communicating settings are electronic mail modules.

Using electronic mail enables large documents to be sent, for example. This is particularly advantageous if the terminal of one of the users that is used for the communications application is not able to send or receive such documents.

In the set-up method of one particular implementation, the second communications modules are fixed or mobile telephone terminals.

In the set-up method of one particular implementation, the connection request is an HTTP request.

According to one particular feature, the set-up method further includes, after the call set-up step, a step of deleting the stored associated identifiers from the memory.

Deleting the associated identifiers enhances security as this means that the identifiers are available for only one call or for a predetermined restricted time period.

Moreover, the memory for storing the associated identifiers can then be of small size.

Another aspect of the disclosure relates to a method of requesting the setting up of a call between first and second users having respective first and second application identifiers, said first and second application identifiers being shared between the users. The method includes connecting the first user to a dedicated communications application via a first communications module, the first user using the first application identifier and the first communications module being adapted to communicate in a first call mode with the second user using the second application identifier; and sending a connection request using the first communications module in a second call mode, which includes the first and second application identifiers.

In one particular implementation, the set-up request method further includes, after reception of a response to the connection request, a step of the first communications module sending a second communications module a predetermined call identifier.

Another aspect of the disclosure relates to a server for communication between first and second users having respective first and second application identifiers, wherein the device includes:
means for receiving a first communications module of the first user a connection request including a first application identifier of the first user and a second application identifier of the second user;
means for obtaining at least one identifier of a second call mode of the first user and at least one identifier of the second call mode of the second user as a function of the first and second application identifiers;
means for storing in a memory an association between the second call mode identifiers of the first and second users; and
means for setting up a call between the first and second users in the second call mode as a function of the stored associated identifiers.

Another aspect of the disclosure relates to a communications terminal including a first communications module adapted to be connected to a dedicated communications application using a first application identifier and to communicate in a first call mode with a second user using a second application identifier, wherein the terminal includes means for sending in the second call mode a connection request including the first and second application identifiers.

Another aspect of the disclosure relates to a computer program product including instructions for executing the steps of a method as described above for setting up a call between first and second users when it is loaded into and executed by a processor.

Another aspect of the disclosure relates to a computer program product including instructions for executing the steps of a method as described above for setting up a call between first and second users when it is loaded into and executed by a processor.

### BRIEF DESCRIPTION OF THE DRAWINGS

Other features and advantages become apparent in the following description of three implementations of the disclosure given by way of non-limiting example and with reference to the appended drawings, in which:

FIG. 1 is a diagram illustrating the general context of a first implementation;

FIG. 2 is a block diagram representing a communications terminal able to execute the steps of a call set-up request method of one implementation;

FIG. 3 is a flowchart illustrating the steps of a call set-up request method and a call set-up method of the first implementation;

FIG. 4 is a diagram illustrating the general context of a second implementation;

FIG. 5 is a flowchart illustrating the steps of a call set-up request method and a call set-up method of the second implementation;

FIG. 6 is a diagram illustrating the general context of a third implementation;

FIG. 7 is a flowchart illustrating the steps of a call set-up request method and a call set-up method of the third implementation; and

FIG. 8 is a block diagram representing a server able to execute the steps of a call set-up method of one implementation.

### DETAILED DESCRIPTION OF ILLUSTRATIVE EMBODIMENTS

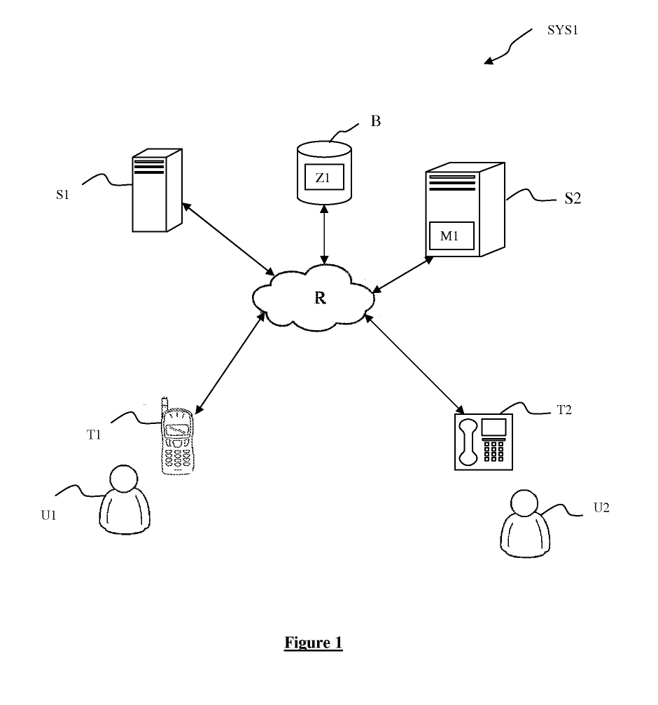

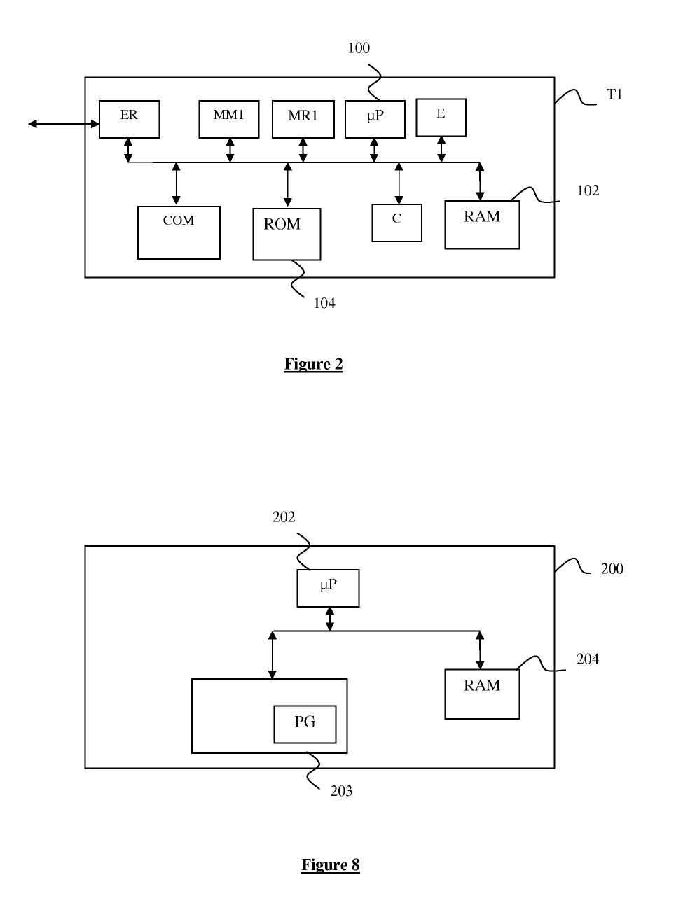

A call set-up method and a call set-up request method of a first implementation of the disclosure are described below with reference to FIGS. 1 and 2.

In this implementation, the call to be set up is a telephone conversation.

Referring to FIG. 1, a system SYS1 includes an instant messaging server S1 and a call server S2.

The system SYS1 also includes a memory B, for example a database, accessible by the call server S2 via a communications network R.

Alternatively, the memory B is a memory area of the server S2 or a memory area accessible directly by the server S2.

The system SYS1 also includes a first terminal T1 of a first user U1.

The first terminal T1 is a personal digital assistant (PDA), for example, or a mobile telephone.

As shown in FIG. 2, the first terminal T1 of the system SYS1 includes a microprocessor-based processor 100, a random-access memory (RAM) 102, one or more read-only memories (ROM or EEPROM) 104 storing programs that can be executed by the microprocessor, a screen E, and a keyboard C.

The first terminal T1 can include in the conventional way (the following list is not exhaustive): a microphone, a loudspeaker, storage means, etc.

The first terminal T1 includes an instant messaging client module MM1 for accessing an instant messaging service installed on the instant messaging server S1, an associated connection request module MR1, and a data send/receive module ER.

The instant messaging client module MM1 represents a first communications module.

The data send/receive module ER is able to send and receive data via the network R.

The first terminal T1 also includes a communications module COM able to set up a telephone call and to communicate with another terminal via the communications network R.

Alternatively, the call is for sending and receiving a Short Message Service (SMS) message or an electronic mail message.

The communications module COM represents a second communications module.

The system SYS1 also includes a second terminal T2 of a second user U2.

The second terminal T2 of the second user U2 is a fixed telephone, a mobile telephone or a PDA, for example.

In the conventional way, the users U1 and U2 are registered with the instant messaging service by means of a first application identifier IA1 and a second application identifier IA2, respectively.

It is assumed that the first user U1 knows the second application identifier IA2 of the second user U2. Thus the first terminal T1 of the user U1 is able to communicate with a terminal of the second user U2, for example the second terminal T2, via the instant messaging service, i.e. in a first call mode.

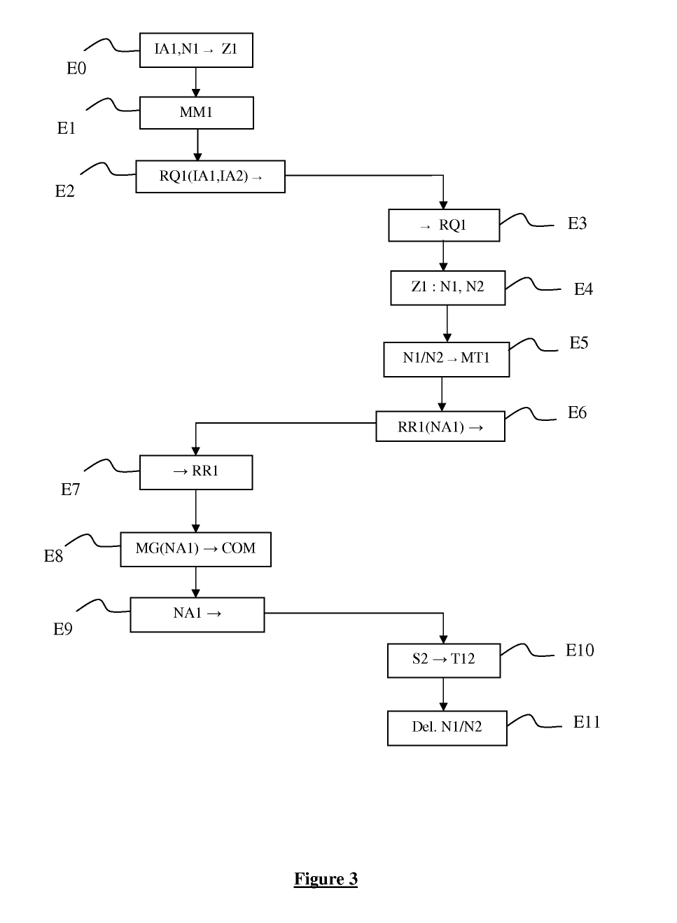

Referring to FIG. 3, during a preliminary registration step E0, the user U1 communicates to the call server S2 the first application identifier IA1 and a telephone number N1 of the first terminal T1 of the first user U1. The call server S2 stores the telephone number N1 of the first terminal T1 in association with the first application identifier IA1 of the first user U1 in an identifier table Z1. The telephone number N1 of the first terminal T1 of the first user U1 is an identifier of a second call mode of the user U1.

The identifier table Z1 is stored in the memory B, for example.

The registration step EU is carried out by the user U1, for example by accessing a registration web service installed on the call server S2.

Alternatively, the registration step is carried out using the instant messaging server S1, for example when registering for the instant messaging service.

Alternatively, a plurality of second call mode identifiers of the user U1 may be stored in association with the first application identifier IA1. For example, the telephone number N1 and an electronic mail address of the first user U1 may be stored in association with the first application identifier IA1.

During a second preliminary registration step (not represented in the figure), the second user U2 sends the call server S2 the second application identifier IA2 and a telephone number N2 of the second terminal T2. Following the reception of this information, the call server S2 stores the telephone number N2 of the second terminal T2 in association with the second application identifier IA2. The telephone number N2 of the second terminal T2 of the second user U2 is an identifier of a second call mode of the user U2.

During a step E1, the first user U1 is connected to the instant messaging service via the instant messaging client module MM1. The user U1 is thus able to communicate in a first call mode with other users of the instant messaging service and in particular with the second user U2.

During a step E2, following a request from the first user U1, the connection module MDR associated with the instant messaging module MM1 of the first terminal T1 sends the call server S2 via the send/receive module ER a request RQ1 for connection to the user U2 including the first application identifier IA1 of the first user U1 and the second application identifier IA2 of the second user U2.

For example, and to be more precise, the request from the first user U1 entails entering a predetermined code such as a combination of key strokes on the keyboard C. Following the detection of this code, the connection request module MR1 prompts the first user U1 to select an application identifier of a user. For example, the second application identifier IA2 is selected from a list of contacts of the first user U1.

The request RQ1 is an HTTP request, for example.

Alternatively, the second application identifier IA2 is entered via the keyboard C of the first terminal T1.

It should be pointed out that the second user U2 may optionally be in communication with the first user U1 via the instant messaging service at the time of the connection request from the first user U1.

Alternatively, the request RQ1 also includes information relating to the connection type.

In the implementation described here, the connection type is a telephone conversation, for example. Alternatively, the connection type is an SMS (Short Message Service) message or electronic mail message, for example.

The request transmission step E2 is followed by a step E3 during which the call server S2 receives the connection request RQ1.

During a subsequent step E4, the call server S2 looks up in the identifier table Z1 a first second call mode identifier associated with the first user U1 and a second second call mode identifier associated with the second user U2.

If there is no second call mode identifier associated with either user in the identifier table Z1, one of the two users is not registered for the connection service and the call server S2 does not progress the request from the first terminal T1.

If the connection request RQ1 includes a connection type, the step E4 looks up in the identifier table Z1 first and second second call mode identifiers matching the connection type. For example, the identifier looked for is a mobile terminal number if the connection is of the SMS message type.

In the particular implementation described here, the first second call mode identifier obtained during the step E4 is the telephone number N1 of the first user U1 and the second second call mode identifier obtained during the step E4 is the telephone number N2 of the second user U2.

Step E4 is followed by a step E5 during which the call server S2 stores in a temporary memory M1 of the call server S2 the second second call mode identifier N2 in association with the first second call mode identifier N1.

During the next step E6, the call server S2 sends a response RR1 to the connection module MR1 of the first terminal T1. The response RR1 includes a number NA1 for accessing the call server S2, for example a telephone number. The access number NA1 represents a call identifier.

The step E6 is followed by a step E7 during which the connection module MR1 of the first terminal T1 receives the response RR1 and then, in a step E8, sends a message MG to the communications module COM of the first terminal T1. The message MG is for example an instruction to dial the access number NA1.

During a subsequent step E9, the communications module COM dials the access number NA1 of the call server S2 contained in the message MG and thus sets up a telephone call to the call server S2 via the network R and the send/receive module ER.

Alternatively, the access number NA1 is known to the connection request module MR1 and is not sent in the response RR1. The response RR1 is then acceptance by the call server S2 of the connection request, for example.

Step E9 is followed by a step E10 during which the call server S2 calls the terminal T2 of the second user U2 and connects the first terminal T1 of the first user U1 and the second terminal T2 of the second user U2. The connection set up in this way represents a second call mode call.

During a step E11, the first second call mode identifier N1 and the second second call mode identifier N2 are deleted from the temporary memory M1 by the call server S2, for example at the end of a predetermined time period.

Alternatively, during the step E8, the message RR1 received during the step E7 is displayed on the screen E of the terminal T1 and, during the next step E9, the user U1 dials the access number NA1 of the call server S2 contained in the message MG on the terminal T1 and thus sets up a telephone call to the call server S2.

Alternatively, the second call mode identifier of the first user is the telephone number of another terminal of that user, for example, and during the step E9 the access number NA1 of the call server S2 is entered on that other terminal and the call is set up from that terminal.

The read-only memory 104 of the terminal T1 of the first user includes registers storing a computer program including program instructions for executing the call set-up request method as described with reference to FIGS. 1 to 3.

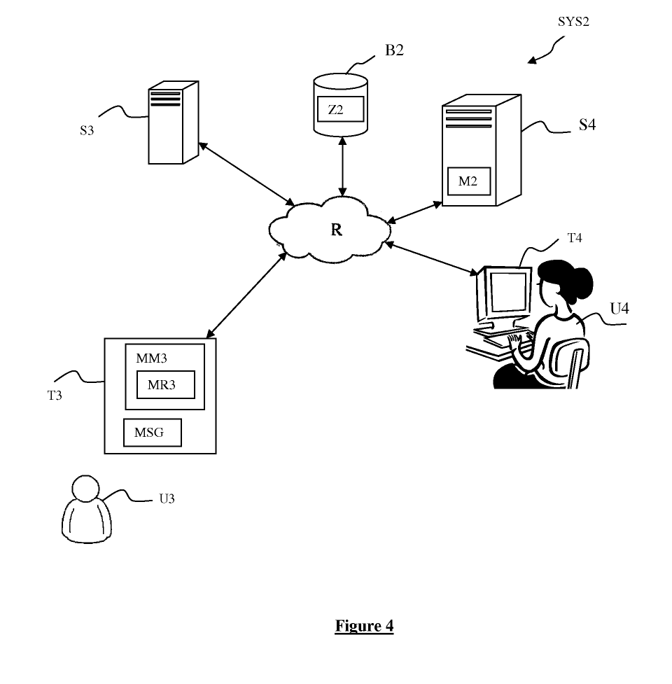

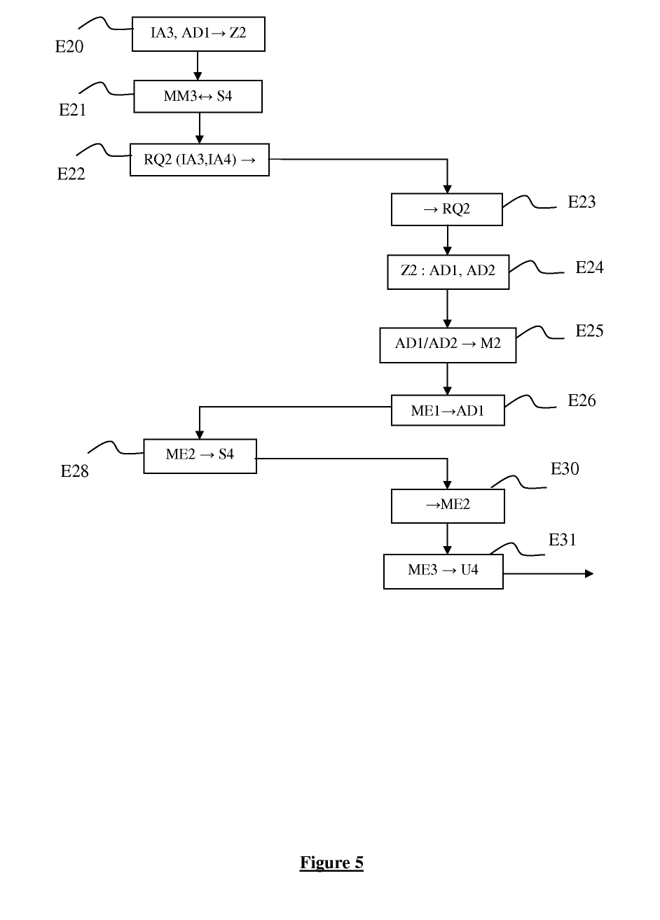

A call set-up method and a call set-up request method of a second implementation are described below with reference to FIGS. 4 and 5.

In this implementation, the call set up is one for sending an electronic mail message.

Referring to FIG. 4, a system SYS2 comprises an instant messaging server S3 and a call server S4.

The system S2 also comprises a memory B2 accessible by the call server S4 via a communications network R.

The system SYS2 also includes a terminal T3 of a first user U3. The terminal T3 is a personal computer (PC), for example.

Alternatively, the terminal T3 is a mobile telephone or a PDA, for example.

An instant messaging client module MM3 installed in the terminal T3 enables the first user U3 to access instant messaging services installed on the server S3. The instant messaging client module MM3 represents a first communications module.

The instant messaging client module MM3 includes a connection request module MR3.

The terminal T3 also includes an electronic mail client module MSG for sending and receiving electronic mail messages using a personal electronic mail address of the user. The electronic mail client module MSG represents a second communications module.

The system SYS2 also includes a terminal T4 of a second user U4. The terminal T4 of the second user U4 is a personal computer (PC), for example.

In the conventional way, the users U3 and U4 are registered with the instant messaging service by means of a first application identifier IA3 and a second application identifier IA4, respectively.

The first user U3 knows the second application identifier IA4 of the second user U4. Thus the terminal T3 of the first user U3 is able to communicate with the second user U4 via the instant messaging service, i.e. in a first call mode.

Referring to FIG. 5, during a preliminary registration step E20, the first user U3 communicates to the call server S4 the first application identifier IA3 and a first electronic mail address AD1. The call server S4 stores the mail address AD1 in association with the first application identifier IA3 in an identifier table Z2. The electronic mail address AD1 is an identifier of a second call mode of the first user U3.

During a second preliminary registration step (not represented in the figure), the second user U4 sends the call server S4 the second application identifier IA4 and a second electronic mail address AD2 and the call server S4 registers the second electronic mail address AD2 in association with the second application identifier IA4. The electronic mail address AD2 is an identifier of a second call mode of the second user U4.

During a step E21 similar to the step E1, the first user U3 is connected to the instant messaging service via the instant messaging client module MM3. The user U3 is thus able to communicate in a first call mode with other users of the instant messaging service and in particular with the second user U4.

During a step E22, the connection module MR3 of the instant messaging module MM3 of the terminal T3 of the first user U3 sends the call server S4 a request RQ2 for connection to the first user U4 including the first application identifier IA3 of the first user U3 and the second identifier IA4 of the second user U4.

To be more precise, the connection request is initiated by the first user U3 by activating an icon displayed on a screen of the terminal T3. During activation of the icon, for example by double clicking it, the connection request module MR3 prompts the first user U3 to select an application identifier of a user, for example from a list of contacts of the first user U3.

The request sending step E22 is followed by a step E23 during which the call server S4 receives the connection request RQ2.

During a subsequent step E24, the call server S4 accesses the identifier table Z2 and obtains an identifier of the second call mode associated with the first user U3 and a second call mode identifier associated with the second user U4.

In the particular implementation described here, the second call mode identifier associated with the first user U3 obtained is the electronic mail address AD1 of the first user U3 and the second call mode identifier associated with the second user U4 obtained is the electronic mail address AD2 of the second user U4.

The step E24 is followed by a step E25 during which the call server S4 stores in a temporary memory M2 of the call server S4 the second call mode identifier AD2 of the second user U4 in association with the second call mode identifier AD1 of the first user U3.

During the next step E26, the call server S4 sends the first user U3 an electronic mail message ME1 informing it that it is authorized to communicate with the second user U4 via the call server S4 using the first electronic mail address AD1, i.e. the second call mode identifier AD1 of the first user U3 stored in the memory M2.

During a subsequent step E28, the first user U3 accesses their electronic mail via the second communications module MSG of the terminal T3 or via another terminal, composes an electronic message ME2 the content of which is intended for the second user U4, and sends it to the call server S4 in response to the message ME1 sent during the step E26.

The message ME2 has a large attachment, for example.

The electronic message ME2 is received by the call server S4 during a step E30.

The step E30 is followed by a step E31 during which the call server S4 accesses the memory M2, retrieves the second call mode identifier AD2 stored in association with the second call mode identifier AD1 of the first user U3, and sends an electronic mail message ME3 to the second user U4 using the second call mode identifier AD2 read in the memory M2. The sender of this electronic mail message ME3 is the call server S4. The content of this message is the content of the message ME2 sent by the first user U3.

Thus the first user U3 may transmit a message to the second user U4 without knowing the electronic mail address of the second user U4. Moreover, during such sending, the electronic mail address of the first user U3 is not communicated to the second user U4.

If during the step E31 no second call mode identifier stored in association with the second call mode identifier AD1 of the first user is found, the process halts and the message is not sent.

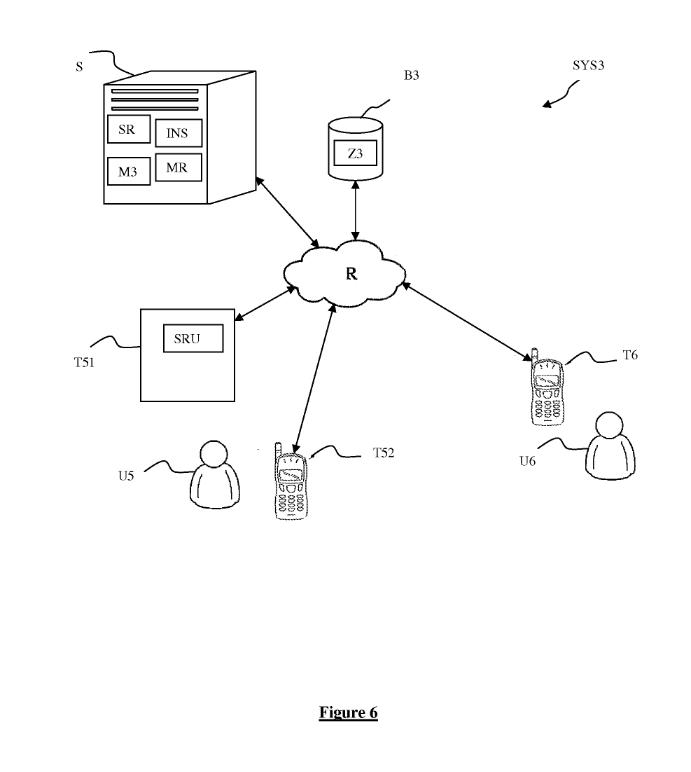

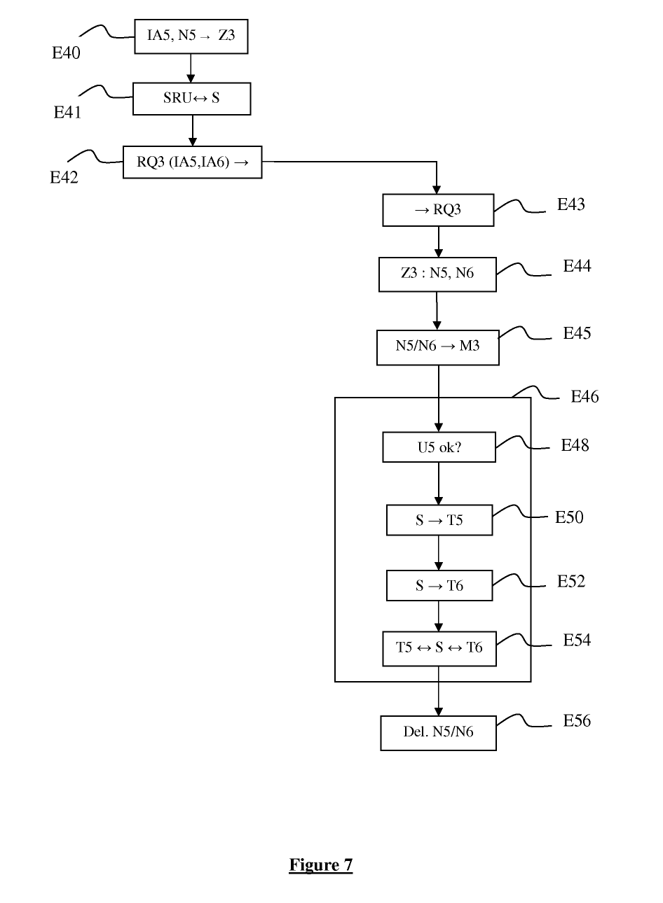

A call set-up method and a call set-up request method of a third implementation are described below with reference to FIGS. 6 and 7.

In this third implementation, the call to be set up is a telephone conversation.

Referring to FIG. 6, a system SYS3 includes a server S.

The system SYS3 also includes a memory B3 accessible by the server S via a communications network R.

Alternatively, the memory B3 is a memory of the server S.

The server S hosts a module SR offering a social network service.

As is known in the art, a social network enables members of a community who subscribe to the service to share information.

The server S also includes a registration module INS and a connection module MR.

The system SYS3 also includes a first terminal T51 and a second terminal T52 of a first user U5.

The first terminal T51 is a personal computer (PC), for example.

A social network client module SRU installed on the first terminal T51 enables the user U5 to access the social network via the module SR installed in the server S. The user U5 can thus consult information networked by other users. In particular, the first user U5 can consult information provided by the second user U6. Consulting this information represents a first call mode.

The module SRU represents a first communications module.

The second terminal T52 of the first user U5 is a fixed telephone, a mobile telephone or a personal digital assistant (PDA), for example.

The system SYS3 also includes a terminal T6 of a second user U6. The terminal T6 of the second user U6 is a mobile telephone, for example.

In the conventional manner, the users U5 and U6 are registered with the social network by means of a first application identifier IA5 and a second application identifier IA6, respectively.

Referring to FIG. 7, during a preliminary registration step E40, the first user U5 communicates to the module INS of the server S the first application identifier IA5 and a number, for example the telephone number N5 of the second terminal T52 of the first user U5. The registration module INS stores the number of the second terminal T52 of the first user in association with the first application identifier IA5 in an identifier table Z3 of the memory B3. The telephone number N5 of the second terminal T52 of the first user U5 represents an identifier of a second call mode of the user U5.

During a second preliminary registration step (not represented in the figure), the user U6 sends the registration module INS of the server S the second application identifier IA6 and a telephone number N6 of the terminal T6 and the registration module INS registers the number of the terminal T6 of the second user U6 in association with the second application identifier IA6. The telephone number N6 of the terminal T6 of the second user U6 represents an identifier of a second call mode of the user U6.

During a step E41, the first user U5 is connected to the social network via the user module SRU of the social network.

During a step E42, the user module SRU of the social network sends the connection module MR of the server S a request RQ3 for connection to the user U6 including the first application identifier IA5 of the user U5 and the second application identifier IA6 of the user U6.

Alternatively, the connection request RQ3 includes information enabling the connection module MR to find the first and second application identifiers.

The step E42 of sending this request is followed by a step E43 in which the connection module MR receives the connection request RQ3.

During the next step E44 the connection module MR of the server S obtains the identifier N5 of the second call mode associated with the first application identifier IA5 of the first user U5 and the identifier N6 of the second call mode associated with the second application identifier IA6 of the second user U6 by reading them in the identifier table Z3.

The step E44 is followed by a step E45 in which the connection module MR stores in a temporary memory M3 of the server S the identifier N6 of the second call mode of the second user U6 in association with the identifier N5 of the second call mode of the first user U5.

During the next step E46, the connection module MR sets up a call between the user U5 and the user U6 in the second call mode.

To be more precise, during a first substep E48, the connection module MR calls the second user U6, for example using the identifier of the second user, to determine whether it agrees to communicate with the first user in the second call mode.

If the second user U6 refuses this call, the module MR deletes the association of two second call mode identifiers from the memory and the process halts. The module SR may optionally advise the first user of the refusal by the second user U6.

The substep E48 makes it possible to add an additional level of security by enabling the second user to refuse a call.

The substep 48 is followed by a substep E50 during which the module MR initiates a call to the second terminal T52 of the first user U5 using the first identifier N5 of the second call mode of the first user U5.

Then, during a second substep E52, the connection module MR initiates a call to the terminal T6 of the second user U6 using the identifier N6 of the second call mode of the second user U6 stored in the memory M3 in association with the identifier N5.

Finally, in a third substep E54, the connection module MR relays the message sent by the user U5 to the user U6 and the information sent by the user U6 to the user U5.

Thus the user U5 is able to communicate with the user U6 in a second call mode. The server S is advantageously the sender and thus enables the two users to communicate with each other without disclosing their terminal number to the other user.

At the end of the conversation, during a step E56, the connection module MR of the server S deletes from the temporary memory M3 the identifier N5 of the second call mode of the first user U5 and the identifier N6 of the associated second call mode.

In an implementation represented in FIG. 8, a server implementing a call set-up method of such as that described herein is for example a microcomputer 200 that includes in known manner a microprocessor-based processor 202, a read-only memory (ROM or EEPROM) 203, and a random-access memory (RAM) 204.

The server 200 may conventionally include (the following list is not exhaustive): a keyboard, a screen, storage means, etc.

The read-only memory 203 includes registers storing a computer program PG including program instructions adapted to execute the steps of a call set-up method of the disclosure.

On powering up, the program PG stored in the read-only memory 203 is transferred into the random-access memory that then contains executable code and registers for storing the variables necessary to implement a step of receiving from a first communications module a connection request including first and second application identifiers, a step of obtaining at least one identifier of a second call mode of the first user and at least one identifier of the second call mode of the second user as a function of the first and second application identifiers, a step of storing in a memory the association between the two identifiers of the second call mode, and a step of setting up a call between the first and second users in the second call mode as a function of the stored associated identifiers.

More generally, storage means readable by a computer or a microprocessor, integrated into the device or not, and where appropriate removable, store a program executing the steps of the call set-up method.

Although the present disclosure has been described with reference to one or more examples, workers skilled in the art will recognize that changes may be made in form and detail without departing from the scope of the disclosure and/or the appended claims.

What is claimed is:

1. A method of setting up a call between first and second users having respective first and second application identifiers, said first and second application identifiers being shared between the users, the first user being connected to a dedicated communications application via a first communications module and using the first application identifier, and the first communications module being able to communicate in a first call mode with the second user using the second application identifier, wherein the method includes:
a step of receiving from the first communications module a connection request including the first and second application identifiers;
a step of obtaining at least one identifier of a second call mode of the first user and at least one identifier of the second call mode of the second user as a function of the first and second application identifiers;
a step of storing in a memory the association between the second call mode identifiers of the first and second users; and
a step of setting up a call between the first and second users in the second call mode as a function of the stored associated identifiers.

2. The method according to claim 1, further including a communications step initiated by a second communications module of the first user using a predetermined call identifier, and wherein the step of setting up a call includes a step of calling a second communications module of the second user.

3. The method according to claim 2, wherein the call identifier is sent in response to the connection request.

4. The method according to claim 1, wherein the step of setting up a call includes a first step of calling a second communications module of the first user and a second step of calling a second communications module of the second user.

5. The method according to claim 4, wherein the second communications modules are electronic mail modules.

6. The method according to claim 4, wherein the second communications modules are telephone terminals.

7. The method according to claim 1, wherein the connection request is an HTTP request.

8. The method according to claim 1, further including, after the step of setting up a call, a step of deleting the stored associated identifiers from the memory.

9. A method of requesting setting up of a call between first and second users having respective first and second application identifiers, said first and second application identifiers being shared between the users, the method comprising:
connecting the first user to a dedicated communications application via a first communications module, the first user using the first application identifier and the first communication module being adapted to communicate in a first call mode with the second user using the second application identifier, and
sending a connection request using the first communications module in a second call mode, which includes the first and second application identifiers.

10. The method according to claim 9, further including, after reception of a response to the connection request, a step of the first communications module sending a second communications module a predetermined call identifier.

11. A server for communication between first and second users having respective first and second application identifiers, wherein the server includes:
means for receiving from a first communications module of the first user a connection request including a first application identifier of the first user and a second application identifier of the second user;
means for obtaining at least one identifier of a second call mode of the first user and at least one identifier of the second call mode of the second user as a function of the first and second application identifiers;
means for storing in a memory an association between the second call mode identifiers of the first and second users; and
means for setting up a call between the first and second users in the second call mode as a function of the stored associated identifiers.

12. A communications terminal including:
a first communications module adapted to be connected to a dedicated communications application using a first application identifier and to communicate in a first call mode with a second user using a second application identifier; and
means for sending in the second call mode a connection request including the first and second application identifiers.

13. A computer program product including instructions for executing a method for setting up a call between first and second users when the program is loaded into and executed by a processor, wherein the first and second users have respective first and second application identifiers, said first and second application identifiers being shared between the users, the first user being connected to a dedicated communications application via a first communications module and using the first application identifier, and the first communications module being able to communicate in a first call mode with the second user using the second application identifier, wherein the method comprises:
a step of receiving from the first communications module a connection request including the first and second application identifiers;
a step of obtaining at least one identifier of a second call mode of the first user and at least one identifier of the second call mode of the second user as a function of the first and second application identifiers;
a step of storing in a memory the association between the second call mode identifiers of the first and second users; and
a step of setting up a call between the first and second users in the second call mode as a function of the stored associated identifiers.

14. A computer program product including instructions for executing a method for setting up a call between first and second users when the program is loaded into and executed by a processor, wherein the first and second users have respective first and second application identifiers, said first and second application identifiers being shared between the users, the method comprising:
connecting the first user to a dedicated communications application via a first communications module, the first user using the first application identifier and the first communication module being adapted to communicate in a first call mode with the second user using the second application identifier, and
sending a connection request using the first communications module in a second call mode, which includes the first and second application identifiers.
